(19) United States
(12) Patent Application Publication
(10) Pub. No.: US 2004/0003306 A1
(43) Pub. Date: Jan. 1, 2004

(54) Information processing apparatus and power supply method used in the apparatus

(75) Inventor: Mikio Oomori, Hamura-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/425,745

(22) Filed: Apr. 30, 2003

(30) Foreign Application Priority Data
Jun. 28, 2002 (JP) 2002-191393

(51) Int. Cl. G06F 1/26

(52) U.S. Cl. 713/300

(57) ABSTRACT

An information processing apparatus is operated by externally supplied DC power. The apparatus includes an external redundant power supply device including a plurality of power supply units each of which converts AC power into DC power, a housing which accommodates a plurality of devices, a DC power input terminal provided on the housing and configured to receive the DC power from the redundant power supply device, and a power supply circuit provided in the housing and configured to generate a power supply voltage, which is to be applied to each of the devices, from the DC power received by the DC power input terminal.

### CROSS-REFERENCE TO RELATED APPLICATIONS

This application is based upon and claims the benefit of priority from the prior Japanese Patent Application No. 2002-191393, filed Jun. 28, 2002, the entire contents of which are incorporated herein by reference.

### BACKGROUND OF THE INVENTION

1. Field of the Invention

The present invention relates to an information processing apparatus such as a server computer and a power supply method used in the information processing apparatus.

2. Description of the Related Art

In general, a redundant power supply system is used in an information processing apparatus such as a server computer in order to improve the reliability of the operation of the apparatus. The redundant power supply system includes two or more power supply devices. The power supply devices each have a unit for converting alternating-current power (AC power) into direct-current power (DC power) and a unit for generating a desired operating power supply voltage from the DC power such that each power supply device can supply operating power to the system by itself.

The housing of a server computer to which the above redundant power supply system is applied accommodates two or more power supply devices. Even though one of the power supply devices fails, the other can supply a stable operating power supply voltage to respective components that make up the server computer.

In a conventional redundant power supply system, however, the entire configuration of a power supply device including a unit for converting AC power into DC power and a unit for generating a desired operating power supply voltage from the DC power is multiplexed. If, therefore, a dual-redundant power supply system is applied to a server computer, the space required in the housing of the server computer is twice as large as that in the housing of a server computer to which a normal nonredundant power supply system is applied.

Recently, it has been demanded that server computers should decrease in size. It is thus necessary to achieve a new redundant power supply system that is suitable for downsizing of an information processing apparatus such as a server computer.

### BRIEF SUMMARY OF THE INVENTION

According to an embodiment of the present invention, there is provided an information processing apparatus which is operated by externally supplied DC power, comprising an external redundant power supply device including a plurality of power supply units each of which converts AC power into DC power, a housing which accommodates a plurality of devices, a DC power input terminal provided on the housing and configured to receive the DC power from the redundant power supply device, and a power supply circuit provided in the housing and configured to generate a power supply voltage, which is to be applied to each of the devices, from the DC power received by the DC power input terminal.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of an information processing apparatus according to an embodiment of the present invention and that of a redundant power supply device which supplies DC power to the apparatus;

FIG. 2 is a circuit diagram showing a configuration of two power supply units provided in the redundant power supply device shown in FIG. 1 and that of a DC/DC converter provided in the information processing apparatus shown in FIG. 1;

FIG. 3 is a block diagram showing an example of a connection between the information processing apparatus and the redundant power supply device both shown in FIG. 1;

FIG. 4 is a block diagram showing an expansion I/O device provided in the redundant power supply device shown in FIG. 1;

FIG. 5 is a block diagram showing another configuration of the information processing apparatus according to the embodiment of the present invention; and

FIG. 6 is a circuit diagram showing a configuration of two DC/DC converters provided in the information processing apparatus shown in FIG. 5.

### DETAILED DESCRIPTION OF THE INVENTION

An embodiment of the present invention will now be described with reference to the accompanying drawings.

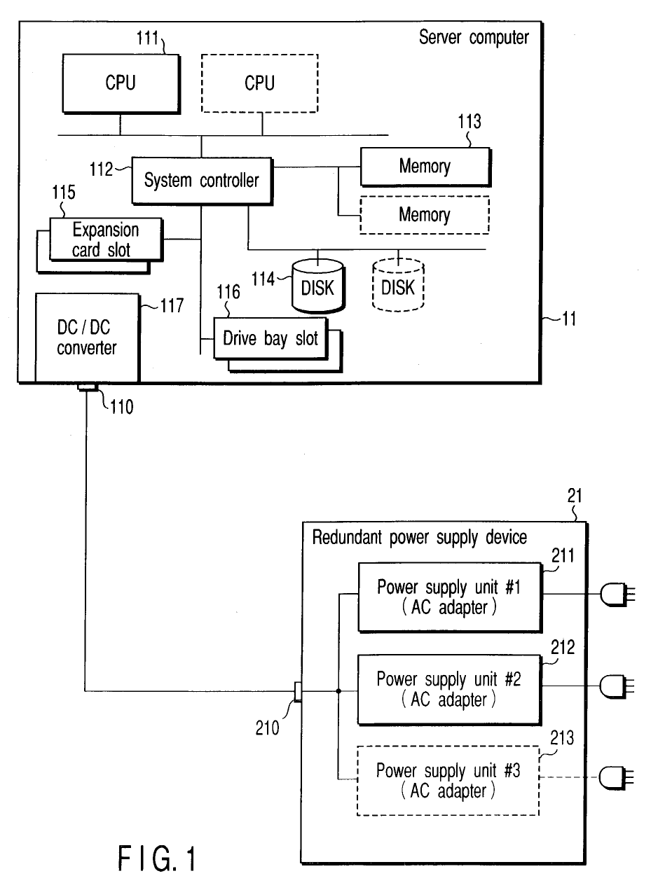

FIG. 1 shows an information processing apparatus according to an embodiment of the present invention. The information processing apparatus functions as a server computer 11. The server computer 11 can be operated by direct-current power (DC power) supplied from an external redundant power supply device 21 through a power supply cable.

As shown in FIG. 1, the housing of the server computer 11 includes a CPU 111, a system controller 112, a memory 113, a hard disk driver 114, a plurality of expansion card slots 115, a plurality of drive bay slots 116 and a DC/DC converter 117.

The configuration of the server computer 11 corresponds to that of a multiprocessor. Two or more CPUs 111 can be mounted on a motherboard of the server computer 11. An expansion card such as a PCI (peripheral component interconnect) card can be inserted into each of the expansion card slots 115. The drive bay slots 116 are used to incorporate a drive unit such as a CD-ROM drive and a flexible disk drive.

The DC/DC converter 117 is a power supply circuit that generates a power supply voltage from the DC power supplied from the external redundant power supply device 21 through the power supply cable. The DC power is to be supplied to each of the components of the server computer 11. The DC power is received by a DC power input terminal 110 that is provided on the housing of the server computer 11. The received DC power is input to the DC/DC converter 117. The DC/DC converter 117 converts the DC power into a power supply voltage that is to be supplied to each of the components.

The redundant power supply device 21 includes a plurality of power supply units 211, 212 and 213 that are redundant. The housing of the device 21 has a plurality of power supply unit insertion slots. The power supply units 211, 212 and 213 are removably inserted into their respective power supply unit insertion slots. A well-known dual-redundant structure or N+1-redundant structure (N is the total number of power supply units necessary for supplying a target amount of power) is used as a structure of the redundant power supply device 21.

Assume that the dual-redundant structure is used in the following descriptions. In this case, the redundant power supply device 21 includes two power supply units, or first and second power supply units 211 and 212 that are redundant.

Each of the power supply units 211 and 212 is an AC/DC converter (AC adapter) that converts alternating-current power (AC power) into direct-current power (DC power). The outputs of the power supply units 211 and 212 are arranged in parallel to a DC power output terminal 210 that is formed on the housing of the redundant power supply device 21. Even though one of the power supply units 211 and 212 fails, the other can supply DC power necessary for operating the server computer 11. In other words, the two power supply units 211 and 212 always perform a parallel operation and generate a given amount of DC power in association with each other. Each of the power supply units 211 and 212 has a capability of generating DC power necessary for operating the server computer 11. Thus, even though one of the power supply units 211 and 212 fails, the other can continue supplying the DC power necessary for operating the server computer 11. The power supply units 211 and 212 operate while monitoring the values of power supply outputs of the redundant power supply device 21. During the operation of both the power supply units 211 and 212, each unit operates using half of the capability thereof.

Usually, a number of electronic components are required to complete an AC/DC converter. As described above, therefore, to provide the power supply units 211 and 212 outside the housing of the server computer 11 as external AC adapters is favorable for downsizing of the housing of the server computer 11. The AC/DC converter requiring a number of electronic components is more likely to fail than the DC/DC converter. If, therefore, the AC/DC converter is duplexed, it can be increased in reliability.

In the foregoing system configuration, the redundant power supply device 21 converts the AC power into specific DC power having a high voltage (e.g., 24V) and then supplies it to the server computer 11 through the power supply cable. In the server computer 11, the DC/DC converter 117 converts the DC power again into different operating power supply voltages (+5V, 12V, −12V, 3.3V, etc.) necessary for operating different devices. Since the voltage value of the DC power is converted again in the server computer 11 as described above, a stable operating power supply voltage can be applied to each device in the server computer 11 even though the voltage value of the DC power supplied through the power supply cable slightly varies.

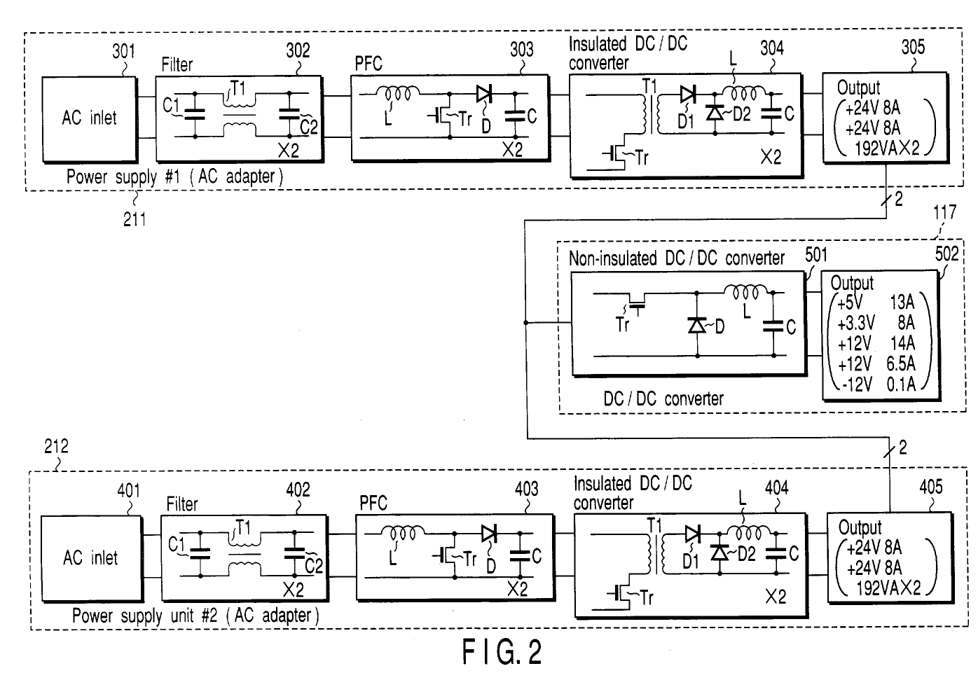

FIG. 2 shows a configuration of each of the power supply units 211 and 212 and that of the DC/DC converter 117.

As shown in FIG. 2, the first power supply unit 211 includes an AC inlet 301, a filter 302, a PFC (power factor correction) circuit 303, an insulated DC/DC converter 304 and an output terminal 305.

The AC inlet 301 receives AC power. The filter 302 is a rectifier circuit that rectifies the AC power and converts it into DC power. The filter 302 includes, for example, two capacitors C1 and C2 and a transformer T1 inserted between these capacitors C1 and C2, as shown in FIG. 2.

The PFC circuit 303 is provided to compensate for a loss of power and can be achieved by, for example, an up-converter including a coil L, a switching transistor Tr, a rectifier diode D and a capacitor C as shown in FIG. 2. The switching of the switching transistor Tr is controlled in response to a PWM (pulse-width modulation) signal input to the gate of the switching transistor Tr.

The insulated DC/DC converter 304 converts a voltage value of the DC power output from the PFC circuit 303 into a DC voltage value of, e.g., 24V. The insulated DC/DC converter 304 can be made up of, for example, a switching transistor Tr, a transformer T1, a rectifier diode D1, a free wheel diode D2, a coil L and a capacitor C. The switching of the switching transistor Tr is controlled in response to a PWM (pulse-width modulation) signal input to the gate of the switching transistor Tr. By controlling a duty ratio of the PWM signal, a DC voltage of +24V can be generated.

The first power supply unit 211 includes, for example, two systems each having the above-described filter 302, PFC circuit 303 and insulated DC/DC converter 304, and the systems generate two DC powers of 192 VA (+24V, 8A). These DC powers are shunted to two power transmission lines, respectively and supplied to the DC/DC converter 117 in the server computer 11. The use of the two power transmission lines aims at transmitting power safely and cause the amount of power transmitted through one power transmission line to fall within a given value (e.g., 240 VA).

Like the first power supply unit 211, the second power supply unit 212 includes an AC inlet 401, a filter 402, a PFC (power factor correction) circuit 403, an insulated DC/DC converter 404 and an output terminal 405.

The AC inlet 401 receives AC power. The filter 402 is a rectifier circuit that rectifies the AC power and converts it into DC power. The filter 402 includes, for example, two capacitors C1 and C2 and a transformer T1 inserted between these capacitors C1 and C2, as shown in FIG. 2.

The PFC circuit 403 is provided to compensate for a loss of power and can be achieved by, for example, an up-converter including a coil L, a switching transistor Tr, a rectifier diode D and a capacitor C as shown in FIG. 2. The switching of the switching transistor Tr is controlled in response to a PWM (pulse-width modulation) signal input to the gate of the switching transistor Tr.

The insulated DC/DC converter 404 converts the DC power output from the PFC circuit 403 into a voltage of, e.g., 24V. The insulated DC/DC converter. 404 can be made up of, for example, a switching transistor Tr, a transformer T1, a rectifier diode D1, a free wheel diode D2, a coil L and a capacitor C. The switching of the switching transistor Tr is controlled in response to a PWM (pulse-width modulation) signal input to the gate of the switching transistor Tr. By controlling a duty ratio of the PWM signal, a DC voltage of +24V can be generated.

The second power supply unit 212 includes, for example, two systems each having the above-described filter 402, PFC circuit 403 and insulated DC/DC converter 404. The systems generate two DC powers of 192VA (+24V, 8A). These DC powers are shunted to two power transmission lines, respectively and supplied to the DC/DC converter 117 in the server computer 11.

As shown in FIG. 2, the DC/DC converter 117 includes a non-insulated DC/DC converter 501 and an output terminal 502. The non-insulated DC/DC converter 501 generates a given operating power supply voltage, which corresponds to each device, from the DC power supplied from the redundant power supply device 21. As shown in FIG. 2, the DC/DC converter 501 can be made up of, for example, a switching transistor Tr, a free wheel diode D, a coil L and a capacitor C. The switching of the switching transistor Tr is controlled in response to a PWM signal input to the gate of the switching transistor Tr.

Actually, the DC/DC converter 117 further includes some regulators. The regulators and DC/DC converter 501 generate a plurality of DC power supply voltages of +5V, +3.3V, +12V, −12V, etc. in association with each other.

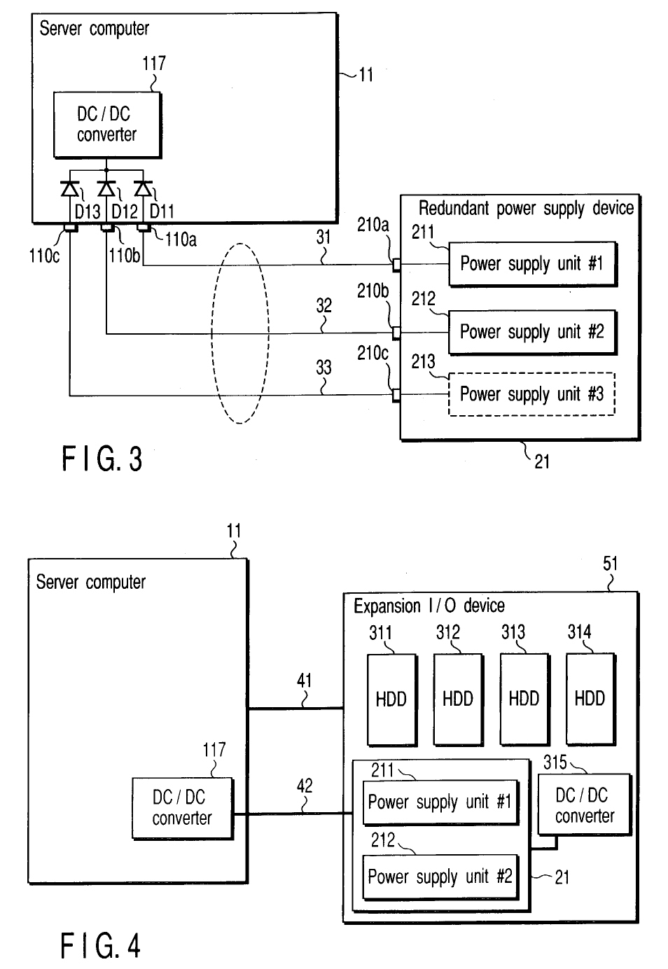

FIG. 3 shows an example of transmission lines of DC power from the redundant power supply device 21 to the server computer 11.

As described above, a plurality of power transmission lines are used to transmit DC power from the redundant power supply device 21 to the server computer 11. Three power transmission lines 31, 32 and 33, which correspond to three power supply units 211, 212 and 213, respectively, are used in the example of FIG. 3. The three power transmission lines 31, 32 and 33 can be enclosed with a single power supply cable or their separate power supply cables.

The output of the first power supply unit 211 is connected to a DC power input terminal 110a, which is formed on the housing of the server computer 11, through a DC power output terminal 210a and the power transmission line 31. Actually, the first power supply unit 211 has two output systems (192 VA×2); therefore, there are two systems each including the DC power output terminal 210a, power transmission line 31 and DC power terminal 110a.

Similarly, the output of the second power supply unit 212 is connected to a DC power input terminal 110b, which is formed on the housing of the server computer 11, through a DC power output terminal 210b and the power transmission line 32. Actually, the second power supply unit 211 has two output systems (192 VA×2); therefore, there are two systems each including the DC power output terminal 210b, power transmission line 32 and DC power input terminal 110b.

If the redundant power supply device 21 has a 2N+1-redundant (N=1) structure, it includes the third power supply unit 213 in addition to the first and second power supply units 211 and 212 described above. The output of the third power supply unit 213 is connected to a DC power input terminal 110c, which is formed on the housing of the server computer 11, through the a DC power output terminal 210c and the power transmission line 33.

In the server computer 11, three diodes D11, D12 and D13 are provided between the DC power input terminals 110a, 110b and 110c and the input terminal of the DC/DC converter 117, respectively. These diodes D11, D12 and D13 can prevent the DC power, which is supplied from a power supply unit that operates normally, from flowing backward to a power supply unit that fails or a power supply unit insertion slot in which no power supply unit is inserted.

If the power transmission lines 31, 32 and 33 are provided on a two-by-two basis (two lines 31, two lines 32 and two lines 33) as described above, diodes D11, D12 and D13 are done on the same basis (two diodes D11, two diodes D12 and two diodes D13).

FIG. 4 shows a case where the redundant power supply device 21 is provided in the housing of an expansion I/O apparatus that is connectable to the server computer 11.

As shown in FIG. 4, the housing of an expansion I/O apparatus 51 accommodates the first and second power supply units 211 and 212 that make up the redundant power supply device 21. The expansion I/O apparatus 51 is an option device that is connected to the server computer 11 when necessary in order to expand the function of the server computer 11. The housing of the expansion I/O apparatus 51 can also accommodate a plurality of peripheral devices such as a hard disk drive (HDD).

In FIG. 4, the housing of the expansion I/O apparatus 51 accommodates four HDDs 311, 312, 313 and 314 that make up a disk array. In this case, the server computer 11 can get access to the HDDs 311, 312, 313 and 314 via a SCSI (small computer system interface) cable 41. The redundant power supply device 21 supplies DC power to the server computer 11 via the power supply cable 42.

The redundant power supply device 21 can be provided in the housing of the expansion I/O apparatus 51. Since, therefore, any dedicated redundant power supply device need not be provided, the entire system configuration can be simplified.

Further, the housing of the expansion I/O apparatus 51 includes a DC/DC converter 315. The DC/DC converter 315 generates power supply voltages, which are to be applied to the HDDs 311, 312, 313 and 314, using the DC power supplied from the redundant power supply device 21. Thus, the redundant power supply device 21 can be used for both a supply of DC power to the server computer 11 and that of power to the expansion I/O apparatus 51.

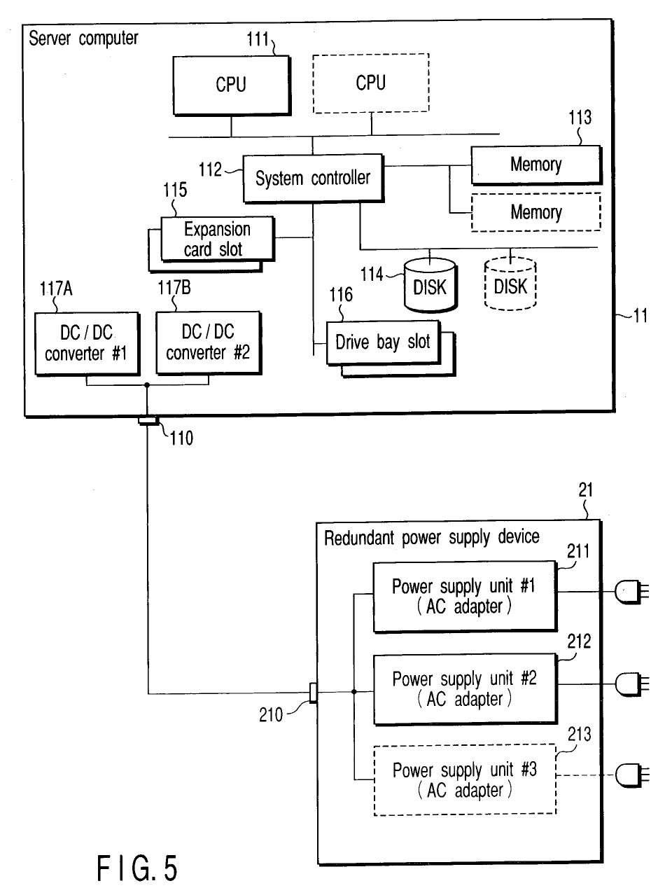

FIG. 5 shows another configuration of the server computer 11.

The server computer 11 shown in FIG. 5 includes a redundant DC/DC converter having two DC/DC converters 117A and 117B. The other configuration is the same as that of the server computer 11 shown in FIG. 1. The DC/DC converters 117A and 117B are redundant, and are connected in parallel to a DC power input terminal 110 to receive DC power.

Both of the DC/DC converters 117A and 117B can generate a power supply voltage, which is to be applied to each of components of the server computer 11, from the DC power supplied from the redundant power supply device 21. Thus, even though one of the DC/DC converters 117A and 117B fails, the other can apply the power supply voltage to each of the components. Needless to say, not the two DC/DC converters 117A and 117B but redundant three or more DC/DC converters can be connected in parallel to the DC power input terminal 110.

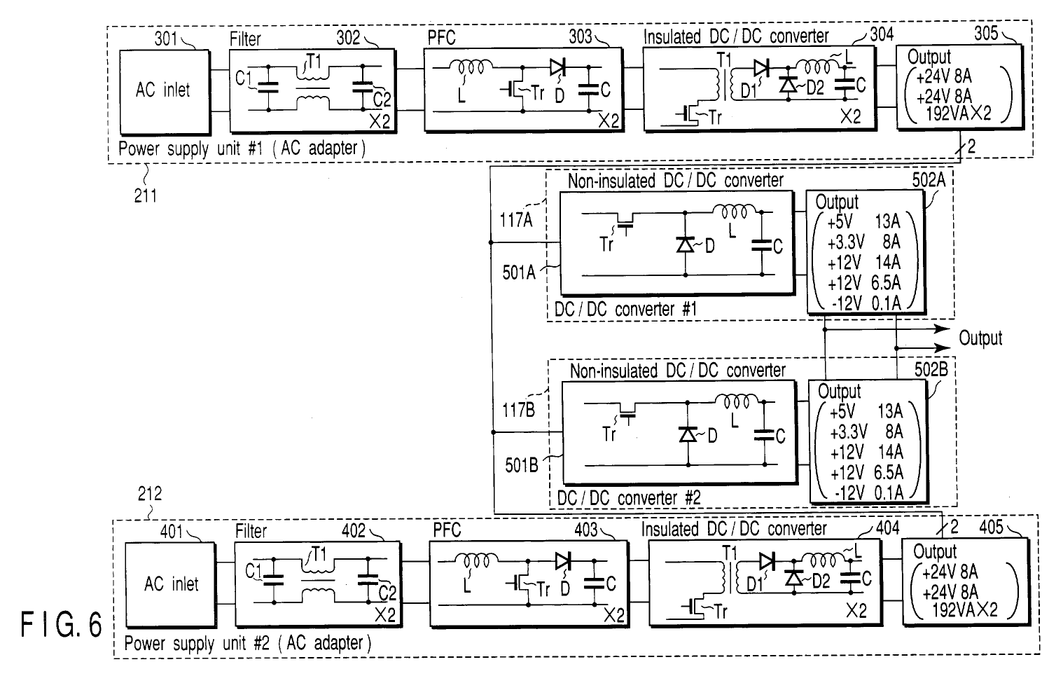

FIG. 6 shows an example of a connection between the power supply units 211, 212 and DC/DC converters 117A, 117B.

The configuration of the power supply units 211 and 212 shown in FIG. 6 is the same as that of the power supply units shown in FIG. 2. The first DC/DC converter 117A includes a non-insulated DC/DC converter 501A and an output terminal 502A. The second DC/DC converter 117B includes a non-insulated DC/DC converter 501B and an output terminal 502B.

The output terminals 502A and 502B are connected to each other such that their output power supply voltages of the same value are connected in wired-OR fashion each other. For example, the output power supply voltage (+5V, 13A) of the output terminal 502A is connected to the output power supply voltage (+5V, 13A) of the output terminal 502B. Similarly, the output power supply voltage (+3.3V, 8A) of the output terminal 502A is connected to the output power supply voltage (+3.3V, 8A) of the output terminal 502B.

According to the embodiment described above, the power supply device which supplies power to the server computer 11 is separated into a power supply unit which converts AC power into DC power and a power supply circuit which generates a desired operating power supply voltage from the DC power. The power supply unit is provided in the external redundant power supply device 21, and the power supply circuit is provided in the server computer 11. Since the power supply circuit can be formed of only electronic components such as DC/DC converters, it can sufficiently be included in the housing of the server computer 11 that is compact. A plurality of redundant power supply units 211 and 212 are provided in the external redundant power supply device 21. Therefore, even though one of the power supply units 211 and 212 fails, the other can supply stable DC power to the server computer 11. Consequently, the housing of the server computer 11 can be downsized without losing the reliability of a power supply.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus which is operated by externally supplied DC (direct-current) power, comprising:
an external redundant power supply device including a plurality of redundant power supply units each of which converts AC (alternating-current) power into DC power;
a housing which accommodates a plurality of devices;
a DC power input terminal provided on the housing and configured to receive the DC power from the redundant power supply device; and
a power supply circuit provided in the housing and configured to generate a power supply voltage, which is to be applied to each of the devices, from the DC power received by the DC power input terminal.

2. The information processing apparatus according to claim 1, wherein the power supply circuit includes at least first and second power supply circuit units that are redundant, and the first and second power supply circuit units are supplied with the DC power from the DC power input terminal.

3. The information processing apparatus according to claim 1, wherein the redundant power supply device includes a housing that is configured to removably accommodate the power supply units.

4. The information processing apparatus according to claim 1, wherein the plurality of power supply units each include a filter which converts AC power into DC power and a DC/DC converter which converts a voltage value of the DC power output from the filter into a given voltage value.

5. The information processing apparatus according to claim 4, wherein the given voltage value obtained by the DC/DC converter in each of the power supply units is higher than the power supply voltage generated by the power supply circuit in the information processing apparatus.

6. The information processing apparatus according to claim 1, further comprising an external expansion I/o apparatus configured to be connected to the housing of the information processing apparatus and accommodate a peripheral device; and
wherein the redundant power supply device is provided in a housing of the expansion I/O apparatus.

7. The information processing apparatus according to claim 6, wherein the expansion I/O apparatus includes a power supply circuit which generates a power supply voltage, which is to be applied to the peripheral device, from the DC power output from the redundant power supply device.

8. The information processing apparatus according to claim 1, wherein the redundant power supply device supplies the DC power to the information processing apparatus through a plurality of power transmission lines.

9. A method of supplying power to an information processing apparatus, comprising:
supplying DC (direct-current) power to the information processing apparatus from an external redundant power supply device including a plurality of redundant power supply units each of which converts AC (alternating-current) power into DC power; and
generating a power supply voltage, which is to be applied to each of devices provided in a housing of the information processing apparatus, from the DC power supplied from the redundant power supply device by a power supply circuit provided in the housing of the information processing apparatus.

10. The method according to claim 9, wherein the power supply circuit includes at least first and second power supply circuit units that are redundant, and the first and second power supply circuit units are supplied with the DC power.

11. The method according to claim 9, wherein the redundant power supply device includes a housing configured to removably accommodate the power supply units.

12. The method according to claim 9, wherein the plurality of power supply units each include a filter which converts AC power into DC power and a DC/DC converter which converts a voltage value of the DC power output from the filter into a given voltage value.

13. The method according to claim 12, wherein the given voltage value obtained by the DC/DC converter in each of the power supply units is higher than the power supply voltage generated by the power supply circuit in the information processing apparatus.

14. An information processing apparatus comprising:
a housing which accommodates a plurality of devices;
an external redundant power supply device including a plurality of power supply units each of which converts AC (alternating-current) power into DC (direct-current) power; and
a redundant power supply circuit provided in the housing, including a plurality of power supply circuit units each of which generates a power supply voltage, which is to be applied to each of the devices, from the DC power supplied from the external redundant power supply device.

15. The information processing apparatus according to claim 14, further comprising an external expansion I/O apparatus configured to be connected to the housing of the information processing apparatus and accommodate a peripheral device; and
wherein the redundant power supply device is provided in a housing of the expansion I/O apparatus.

16. The information processing apparatus according to claim 15, wherein the expansion I/O apparatus includes a power supply circuit which generates a power supply voltage, which is to be applied to the peripheral device, from the DC power output from the redundant power supply device.
